(19) United States
(12) Patent Application Publication
(10) Pub. No.: US 2002/0034935 A1
(43) Pub. Date: Mar. 21, 2002

(54) Communication protocols in networks having split control planes and user planes

(76) Inventors: Frode Bjelland, Arendal (NO); Niclas Carlsson, Jonkoping (SE); Christian Groves, Melbourne (AU)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 09/903,364

(22) Filed: Jul. 11, 2001

Related U.S. Application Data
(60) Provisional application No. 60/217,705, filed on Jul. 12, 2000.

(51) Int. Cl. H04Q 7/20

(52) U.S. Cl. 455/403; 455/414

(57) ABSTRACT

Concepts are mapped between Media Gateway Control protocols (e.g., H.248/MEGACO) and specifications for packet-switched services like the General Packet Radio Service (GPRS), enabling Media Gateway Control protocols to be applied in a GPRS environment. For example, a GPRS user-plane entity can represent part or all of a (GPRS) mobility management context by a (Media Gateway Control protocol) Context. Also, a GPRS user-plane entity can represent at least the part of a (GPRS) PDP context going towards a user-plane peer as a (Media Gateway Control protocol) Termination. Two GPRS Tunneling Protocol (GTP) tunnels related to one PDP context (either a primary PDP context or a secondary PDP context) and going towards the same user plane peer can be represented by a (Media Gateway Control protocol) Stream, and a (GPRS) GTP tunnel containing received packets can be represented by a (Media Gateway Control protocol) Local Descriptor. In addition, a (GPRS) GTP tunnel containing sent packets can be represented by a (Media Gateway Control protocol) Remote Descriptor.

### BACKGROUND

This application claims priority to U.S. Provisional Patent Application No. 60/217,705 that was filed on Jul. 12, 2000, and that is incorporated here by reference.

This invention relates to methods and apparatus for telecommunication and in particular to use of Media Gateway Control protocol concepts in a packet-switched communication system having a split control-plane/user-plane architecture.

In a packet data communication system, information is exchanged as packets of digital data, or datagrams. Each data packet includes address information that enables the system to direct each packet on its own way through the system from a sender to a receiver. Thus, a packet data communication system does not maintain a continuous connection between a sender and a receiver. Packet data communication systems are sometimes called “connection-less” and packet-switched systems, distinguishing them from traditional telephony systems in which continuous connections are established between senders and receivers. Thus, traditional telephony systems are sometimes called “connection-oriented” and circuit-switched systems.

General packet radio service (GPRS) is a packet-switched communication system that is standardized by the European Telecommunications Standards Institute (ETSI) and the Third Generation Partnership Project (3GPP). See for example “Digital Cellular Telecommunications System (Phase 2+) (GSM); General Packet Radio Service (GPRS); Service description; Stage 2”, 3GPP TS 03.60 ver. 7.6.0 Release 1998; and “General Packet Radio Service (GPRS); Service Description; Stage 2”, 3GPP TS 23.060 ver. 3.3.0 Release 1999 (April 2000). GPRS is also described in H. Granbohm et al., “GPRS—General Packet Radio Service”, Ericsson Review No. 2, pp. 82-88 (1999) and in L. Ekeroth et al., “GPRS Support Nodes”, Ericsson Review No. 3, pp. 156-169 (2000).

GPRS operates with circuit-switched, cellular mobile telephone systems such as the Global System for Mobile (GSM) system, also standardized by ETSI and 3GPP, and the U.S. time division multiple access (TDMA) cellular system defined by the TIA/EIA-136 standard promulgated by the Telecommunications Industry Association (TIA) and Electronic Industries Association (EIA). By adding GPRS functionality to GSM and TDMA public land mobile networks (PLMNs), network operators can give their subscribers resource-efficient access to external Internet protocol-based (IP-based) networks like the Internet.

As depicted in FIG. 1, a GSM-style PLMN includes a number of interconnected network nodes, in particular, a mobile switching center/visitor location register (MSCNLR), a home location register (HLR), and base station subsystems (BSS). The BSS handles radio communication with subscribers' mobile stations (MSs) via an air interface Um. The HLR is a database of information about the subscribers that is accessed by the MSCNLR via a D-interface and that is accessed by a serving GPRS support node (SGSN) via a Gr-interface. The MSCNLR routes circuit-switched calls to and from the MSs, communicating with the BSS over an A-interface. It will be appreciated that these nodes are typical of a circuit-switched network such as a PLMN, whether GSM or not. Data transfer and signaling interfaces are indicated in FIG. 1 by solid lines and signaling interfaces are indicated by dotted lines.

Packet data services and GPRS add nodes in a packet-switched portion of the communication network for handling packet data traffic; these nodes interwork with the circuit-switched portion of the communication system depicted in FIG. 1. For example, an SGSN is connected to the BSS via a Gb-interface and resides at the same hierarchical level in the network as the MSCNLR. A gateway GPRS support node (GGSN) is the interconnection point to a packet data network (PDN) via a Gi-interface and is connected to the SGSN via a Gn-interface (which may be an IP backbone). User data to the Internet, directed for example, from a terminal equipment (TE) connected to a mobile terminal (MT), is sent encapsulated over the IP backbone. In FIG. 1, R is a reference point between a non-ISDN compatible TE and an MT. In this application, the end-user's equipment is called a mobile station (MS) whether it is a combination of a phone (MT) and a device such as a computer (TE) or just a phone.

The SGSN and GGSN can be combined into one physical node and deployed at a central point in the network, or a network may include several GGSNs and SGSNs as shown. Packet data streams and short text messages are handled in FIG. 1 by a Short Message Service—Gateway MSC (SMS-GMSC) and an SMS—Interworking MSC (SMS-IWMSC) that communicate with the HLR via a C-interface and with the MSCNLR via an E-interface. As seen in FIG. 1, the SMS-GMSC and SMS-IWMSC exchange short messages with a short message switching center (SM-SC), and the SMS-GMSC communicates with the SGSN via a Gd-interface. It will be appreciated that the nodes depicted in FIG. 1 are typical of a packet-switched network, whether a GPRS network or not.

Most of the interfaces depicted in FIG. 1, and in particular the Gs- and A-interfaces, exchange messages with the help of the Signaling System Number 7 (SS7) that is standardized by ETSI and the American National Standards Institute (ANSI), among others. SS7 in GSM and GPRS uses a message transfer part (MTP) protocol to deliver messages and a signaling connection control part (SCCP) protocol for extended addressing. The SCCP protocol provides for each message to have an SCCP header that has a sub-system number for telling the node receiving the message which application should have the message. An SGSN, for example, typically has different sub-system numbers for communication with the HLR and with the MSCNLR. An MSC usually derives the node type of a communicating peer node based on the sub-system number that may be stored in a database or included in an earlier message.

In a GPRS network, packet data channels (PDCHs) are mapped onto respective timeslots, thereby utilizing the same physical channel structure as ordinary circuit-switched GSM/TDMA channels. All radio resources are managed from a base station controller (BSC) in the BSS, which also includes Base Transceiver Stations (BTS); the pool of physical channels for a given cell can be used as either circuit-switched channels or packet-data channels. By packet multiplexing, the allocated PDCHs can be shared by every GPRS user in the cell, and the number of PDCHs in a cell can be fixed or dynamically allocated to meet fluctuating traffic demands. To support efficient multiplexing of packet traffic to and from mobile stations, or mobile terminals (MTs), packet data traffic channels (PDTCHs), packet associated control channels (PACCHs), and packet data common control channels (PDCCHs) are specified for the air interface Um, although PDCCHs are not always used.

As noted above, an SGSN serves every GPRS subscriber that is physically located within the SGSN's service area. To a large extent, the SGSN does for the packet data service what the MSCNLR does for circuit-switched service. The mobility management functions for GPRS terminals that are performed by an SGSN include attach/detach, user authentication, ciphering, location management, and so on, and an SGSN supports combined mobility management for at least some mobile terminals by interworking with the MSCNLR. An SGSN also manages the logical link to mobile terminals that carries user packet traffic, SMS traffic, and layer-3 signaling between the network and the GPRS terminals. An SGSN also routes and transfers packets between mobile terminals and the GGSN; handles packet data protocol (PDP) contexts (the PDP context defines important parameters, such as the access point name, quality of service, the GGSN to be used, and so on, for connection to the external packet data network); interworks with the radio resource management in the BSS; and generates charging data.

As noted above, the GGSN accommodates the interface to external IP-based networks. Access-server functionality in the GGSN is defined according to standards from the Internet Engineering Task Force (IETF). The GGSN functions as a border gateway between the PLMN and external networks, sets up communication with external packet data networks, authenticates users to external packet networks, routes and tunnels packets to and from the SGSN, and generates charging data.

The MSCNLR also supports integrated mobility management for mobile terminals. GPRS attach and PDP-context activation must be executed in order for GPRS users to connect to external packet data networks. The mobile terminal makes itself known to the network by means of GPRS attach, which corresponds to IMSI attach used for circuit-switched traffic. Once the terminal is attached to the network, the network knows its location and capabilities. For some mobile terminals, circuit-switched IMSI attach and packet-switched GPRS attach can be performed at the same time.

GPRS attach is depicted by FIG. 2. In step 1, the mobile terminal requests that it be attached to the network. The terminal's request, which is sent to the SGSN, includes parameters that indicate its multi-timeslot capabilities, the ciphering algorithms it supports, whether it wants to attach to a packet-switched service or to both packet and circuit-switched services, etc. In step 2, authentication is made between the terminal and SGSN, which may fetch relevant data from the HLR. In step 3, subscriber data from the HLR is inserted into the SGSN; and in step 4, information is passed to the terminal that indicates the terminal is attached to the network.

Before the mobile terminal can communicate with an external PDN (e.g., an IP network), a PDP context must be activated. The PDP context includes parameters that describe the characteristics of the connection to the external PDN, e.g., the address allocated to the MS, access point name (APN), QoS, and so on. PDP contexts may be primary or secondary, in which a secondary PDP context uses the same MS IP address and is connected towards the same APN (i.e., external net) as its respective primary PDP context. A composite PDP context contains one primary and zero or more secondary PDP contexts.

PDP-context activation is depicted in FIG. 3. In step 1, the mobile terminal requests PDP-context activation. In step 2, the SGSN validates the request based on subscription information received from the HLR during GPRS attach. In step 3, the APN is sent to a domain name server (DNS) from the SGSN to find the IP address of the relevant GGSN. In step 4, a logical connection is created between the SGSN and the GGSN (i.e., a GPRS Tunneling Protocol (GTP) tunnel is formed). In step 5, the GGSN assigns a dynamic IP address to the mobile terminal, if required, from the range of IP addresses allocated to the PLMN or externally, from a Remote Authentication Dial-In User Service (RADIUS) server (a fixed IP address from the HLR could also be used). A RADIUS client is included in the GGSN to support Password Authentication Protocol (PAP) and Challenge Handshake Authentication Protocol (CHAP) authentication to external networks with RADIUS servers. After an acknowledgment of the PDP context activation is returned to the MS (step 6), communication between the user and the external PDN (e.g., an Internet Service Provider (ISP) network or a corporate network) can commence (step 7).

Many network operators see an advantage in physically splitting node(s) in a network like that depicted in FIG. 1 into control plane node(s) and user plane node(s), thus better enabling independent scalability of signaling traffic and data traffic. In particular, the number of end-users is scalable independently of the end-user traffic. By connecting each user-plane node to several control-plane nodes and vice versa, it is possible to use the total network capacity more efficiently. Moreover, it is possible to dispose common user-plane nodes between the circuit-switched and the packet-switched portions of the communication network to reduce the necessary network resources even further and to provide a better migration path when circuit-switched equipment is replaced by packet-switched equipment. Also, this enables cheaper replacement of the network nodes handling user-plane traffic as technology evolves.

The Universal Mobile Telecommunication System (UMTS) is a combined circuit-switched and packet-switched communication system. The circuit-switched portion has a split control-plane/user-plane architecture, and therefore physically splitting nodes in the circuit-switched portion of this system is already possible. The packet-switched portion does not have a split architecture, although a logical split already exists in the current specifications of the packet-switched portion and thus it may be just a matter of time before a split architecture is defined.

When a split architecture is implemented, a protocol for communications between control- and user-plane entities must be defined. Two such protocols are the H.248 and Media Gateway Control (MEGACO) protocols, which are similar enough that they will be called the H.248/MEGACO protocol in this application. The H.248/MEGACO protocol defines, in an open and flexible way, a generic framework for information exchange between control-plane and user-plane entities as well as application-specific packages that can be tailored to the different needs of an application like GPRS. The H.248 protocol is being developed by Study Group 16 of the International Telecommunications Union (ITU) (see Draft Recommendation H.248, ITU (Jun. 15, 2000), which is incorporated here by reference). The MEGACO protocol is being developed in the IETF's MEGACO working group (see N. Greene et al., “Megaco Protocol version 0.8”, RFC 2885, IETF (August 2000) and T. Taylor, “Megaco Errata”, RFC 2886, IETF (August 2000), which are the successors to N. Greene et al., “Media Gateway Control Protocol Architecture and Requirements”, RFC 2805, IETF (April 1999)).

In these standardization protocols, the call/application function located in the control plane is called a Media Controller (MC) and the bearer/resource function located in the user plane is called a Media Gateway (MG). An MG normally converts media provided in one type of network to a format required in another type of network, and an MC controls the parts of a call state that pertain to connection control for media channels in an MG. For example, an MG may terminate bearer channels from a circuit-switched network (e.g., DSO channels in a PSTN) and media streams from a packet-switched network (real-time transport protocol (RTP) streams in an IP network).

FIG. 4 depicts such a network that has two nodes and a split architecture. The nodes 402, 404 include respective MCs 406, 408 and respective MGs 410, 412. Communications on the interface between the media controllers, i.e., the control-plane entities, are conducted according to a call/application control protocol. Communications on the interface between the media gateways, i.e., the user-plane entities, are conducted according to a bearer/resource protocol. Communications on the interface between the control-plane and user-plane entities can be conducted according to the H.248/MEGACO protocol.

The H.248/MEGACO protocol is also organized according to user-plane concepts of Contexts, Terminations, Streams, and Descriptors, which can be better understood with the help of FIG. 5.

Contexts and Terminations relate to resources in the user plane. A Termination represents a physical or logical endpoint of flows of information, or media, and encapsulates media stream parameters as well as modem and bearer parameters. A Termination may include zero or more Streams and is identified by a TerminationID. Two Terminations are shown in FIG. 5. A Context logically groups one or more Terminations and is identified by a ContextID. A Context describes the topology (who hears/sees whom, i.e., the flow of media among Terminations) and the media mixing and/or switching parameters if more than two Terminations are involved in the Context. One Context that groups two Terminations is shown in FIG. 5. Each user plane entity (i.e., a media gateway in a split architecture like that shown in FIG. 4) can contain, or handle, several Contexts from several MSs. In general, Terminations are added/removed from Contexts by Add and Subtract commands.

Terminations have properties that have unique PropertyIDs, and related properties are grouped into Descriptors, which may be input or output parameters of commands. For example, a Stream describes a flow of media through a Termination in an MG. A Stream may include a received and/or a sent media flow, and is identified by a StreamID. Four bidirectional Streams are depicted in FIG. 5. The Streams 502, 504 are interconnected in the Context and hence they have the same StreamID. Similarly, the Streams 506, 508 are interconnected in the Context and hence they too have the same StreamID. Several Streams can be set up in one Termination, and FIG. 5 shows each Termination having two Streams. User data received by a media gateway is described by a Local Descriptor and user data sent by a media gateway is described by a Remote Descriptor.

In view of the effort being expended to develop the H.248/MEGACO protocol, it could be beneficial to use that protocol in a wide variety of communication environments, including GPRS for example. Aspects of this effort are described in “Feasibility Study for Transport and Control Separation in the PS CN Domain”, 3GPP TR 23.873 ver. 1.1.0 (January 2001), which is incorporated here by reference. Further aspects are described in U.S. patent applications No. 09/xxx,xxx and No. 09/xxx,xxx, both filed on Jul. 11, 2001, by F. Bjelland et al. Nevertheless, how the H.248/MEGACO protocol might be used in a packet-switched network like GPRS/UMTS or GPRS/TDMA has not been defined. One contributor to this problem may be that the split architecture is not yet standardized for GPRS.

### SUMMARY

In accordance with Applicants' invention, concepts are mapped between Media Gateway Control protocols (e.g., H.248/MEGACO) and specifications for packet-switched systems like GPRS (GPRS/UMTS and GPRS/TDMA). In particular, Applicants' invention enables Media Gateway Control protocols for the Media Controller/Media Gateway split to be applied in a GPRS environment.

In one aspect of Applicants' invention, a method of formatting communication in a telecommunication network having a control-plane entity and a user-plane entity and providing GPRS includes the step of representing in the user-plane entity at least a part of a GPRS mobility management context as a context in accordance with a media gateway control protocol.

In another aspect of Applicants' invention, a method of formatting communication in a telecommunication network having a control-plane entity and a user-plane entity and providing GPRS includes the step of representing in the user-plane entity at least a part of a GPRS PDP context going towards a GPRS user-plane peer as a termination in accordance with a media gateway control protocol. In this method, the GPRS PDP context may contain information related to one communication session and be either a primary GPRS PDP context or a secondary GPRS PDP context. Also in this method, the GPRS PDP context may contain information related to a plurality of communication sessions and be one primary GPRS PDP context and zero or more secondary GPRS PDP contexts.

In another aspect of Applicants' invention, a method of formatting information in a telecommunication network having a control-plane entity and a user-plane entity and providing GPRS includes the step of representing in the user-plane entity two GTP tunnels related to a single GPRS PDP context and going towards a common user-plane peer as a stream in accordance with a media gateway control protocol. In this method, the GPRS PDP context may be either a primary PDP context or a secondary PDP context. Also in this method, a GTP tunnel containing received packets may be represented by a local descriptor in accordance with the media gateway control protocol, and a GTP tunnel containing sent packets may be represented by a remote descriptor in accordance with the media gateway control protocol.

### BRIEF DESCRIPTION OF THE DRAWINGS

The features, objects, and advantages of this invention will be apparent from reading this description in conjunction with the drawings, in which:

FIG. 1 depicts a combined packet-switched and circuit-switched communication network;

FIG. 2 depicts a simplified GPRS attach in a packet-switched network;

FIG. 3 depicts a simplified PDP context activation in a packet-switched network;

FIG. 4 depicts a network architecture in which nodes are split into control-plane and user-plane entities;

FIG. 5 depicts a conceptual organization of media gateway control protocol concepts; and

FIG. 6 depicts a user-plane entity in a split architecture and communication organization of a GPRS serving node.

### DETAILED DESCRIPTION

This description is given in terms of GPRS for convenience only, and it will be appreciated that the principles of the invention can be applied in other packet-switched networks having suitable characteristics.

As partially described above, GPRS is organized according to mobility management (MM) contexts, PDP contexts, and GTP tunnels. In order to understand how a protocol such as H.248/MEGACO can be used for an application like GPRS, it is helpful to map GPRS concepts into H.248/MEGACO concepts, thereby identifying GPRS concepts in a split architecture that correspond to H.248/MEGACO protocol concepts. In particular, the SGSN is the GPRS support node (GSN) that is currently believed to benefit most from a split architecture.

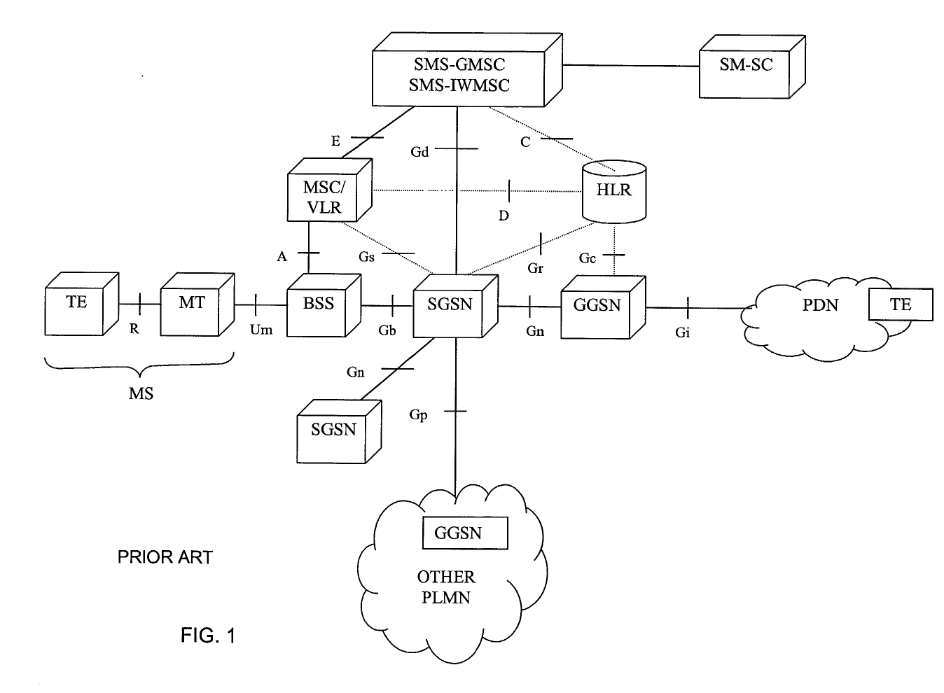

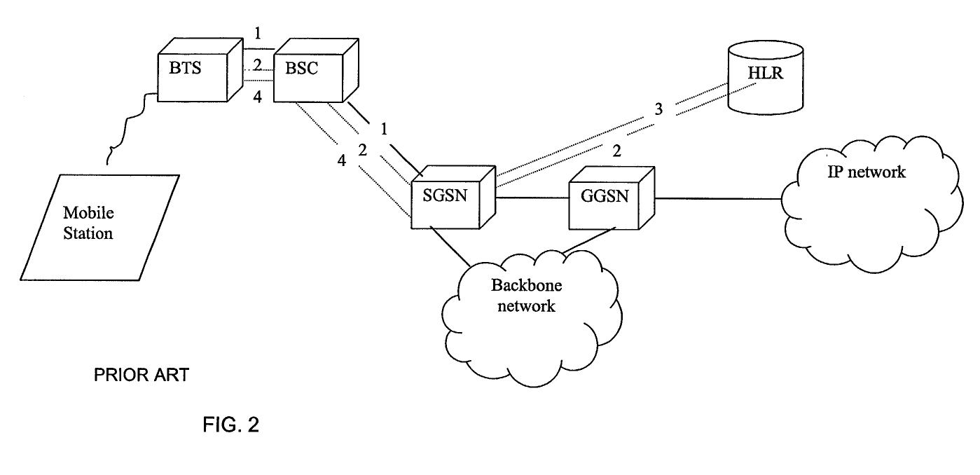

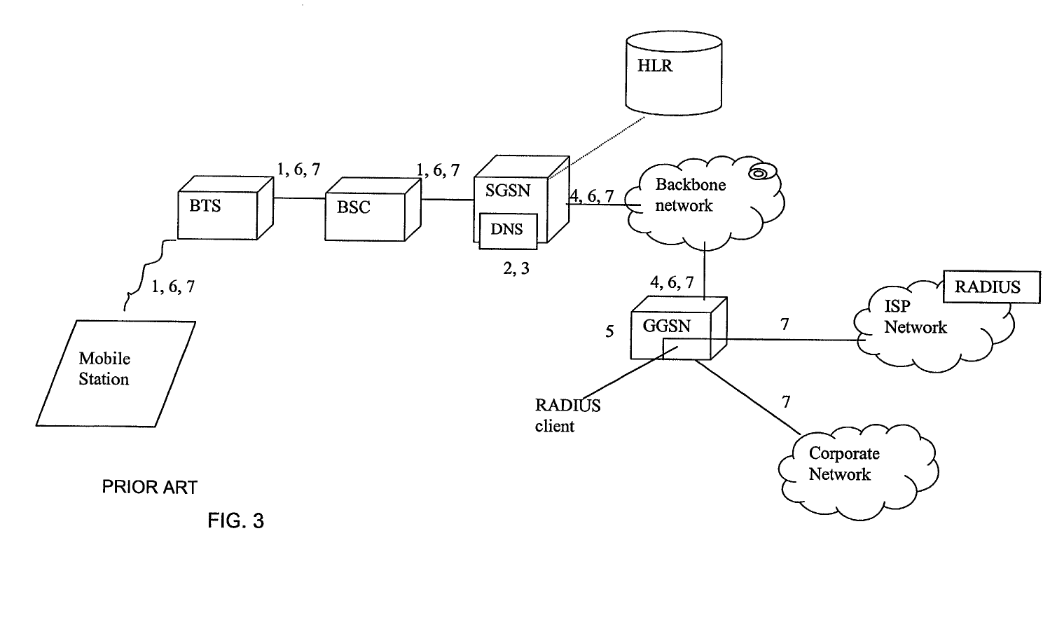

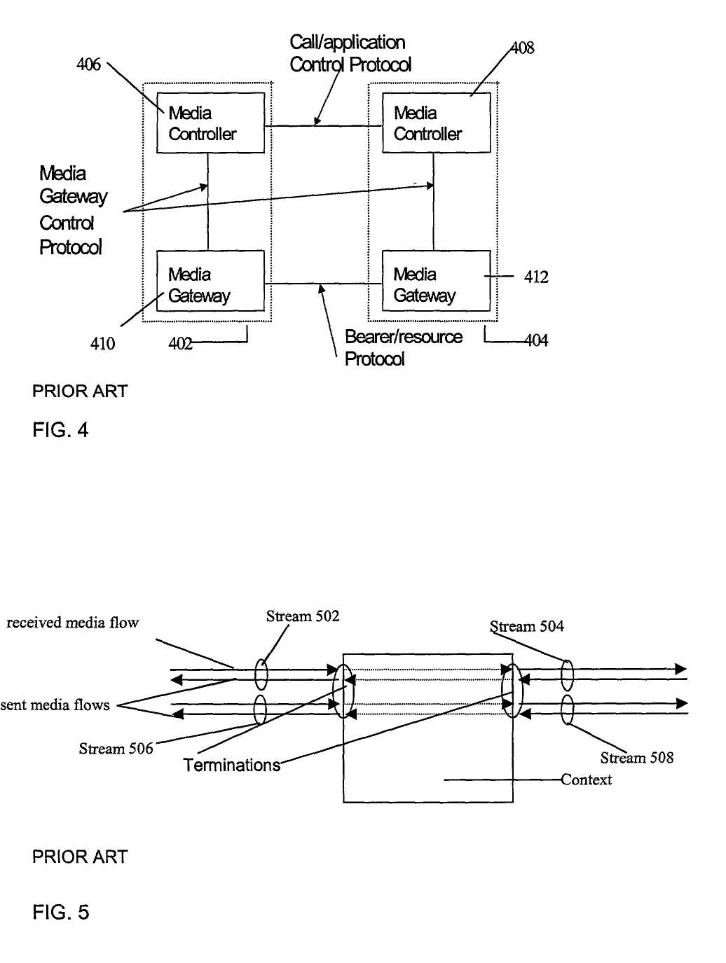

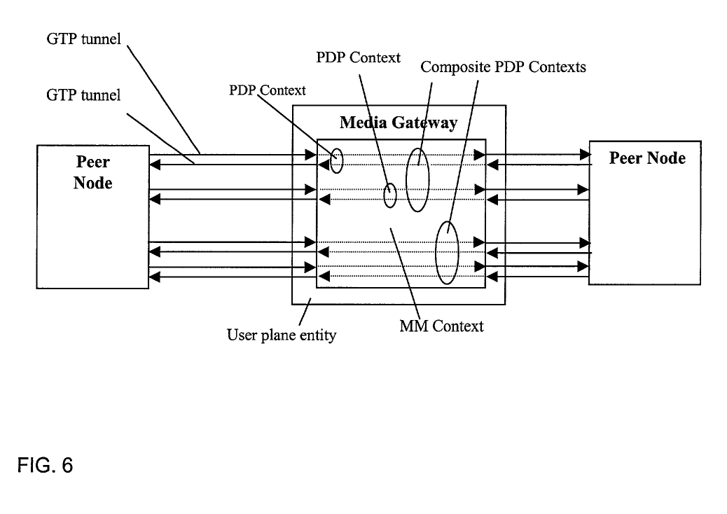

FIG. 6 depicts a Media Gateway (i.e., a user-plane entity) in a split architecture and communication organization of a GPRS serving node, such as an SGSN, in accordance with Applicants' invention. An SGSN may be split into an SGSN server and a packet-switched Media Gateway such as that depicted in FIG. 6, with the server handling all signaling interfaces (e.g., the Gs-, Gr-, Gd-interfaces, etc. shown in FIG. 1) and GTP-control (GTP-C) for the Gn- and Gp-interfaces and the media gateway handling GTP-user (GTP-U) for all traffic (media) interfaces.

A GPRS MM context is the information held in an MS and network nodes for the MS that is related, for example, to movement and security functions of the MS. An MM context would typically contain zero or more composite PDP contexts (two are shown in FIG. 6), and would be identified by the MS's International Mobile Station Identity (IMSI). A GPRS PDP context is either information related to one communication session (i.e., a single PDP context, which can be either a primary or a secondary PDP context) or information related to several sessions (i.e., a composite PDP context, which can be one primary and zero or more secondary PDP contexts). An MM context does not have to be visible in the user plane, but in the control plane, it contains MM data for an MS.

As can be seen from FIGS. 5 and 6, an MM context, or the parts of an MM context that are set up in a Media Gateway, is preferably mapped to an H.248/MEGACO Context. Only the parameters of the MM context that are needed by the Media Gateway need be contained in the H.248/MEGACO Context. Handling the required parts of a GPRS MM context through one H.248/MEGACO Context in the Media Gateway, i.e., in a concentrated way, simplifies the handling of the GPRS MM context. For example, when an MS detaches, the whole corresponding H.248/MEGACO Context can be removed more easily. Also, handling GPRS MM parameters that are relevant to a Media Gateway in a concentrated way, i.e., by an H.248/MEGACO Context, simplifies information handling by the Media Gateway and enables the MG to handle media flow packets correctly. It will be appreciated that “mapping” concepts and “representing” GPRS parameters by H.248/MEGACO parameters simply means re-organizing, or transforming, information organized in one way (e.g., in accordance with GPRS) into the same information organized in a different way (e.g., in accordance with H.248/MEGACO).

FIG. 6 shows two composite PDP contexts, each of which includes a primary PDP context and a secondary PDP context. In either case, a GPRS PDP context can be thought of as dealing with two “half-calls” or “half-sessions”, one directed from the SGSN towards the radio network (UTRAN (for UMTS), BSS (for GSM), etc.) and one directed towards the packet-switched network (a GGSN or another SGSN). Thus, Applicants have recognized that the part of a GPRS PDP context (either a single PDP context or a composite PDP context as described above) having parameters that relate to a connection going towards a peer node (i.e., either “half-call”) is advantageously represented by an H.248/MEGACO Termination. Accordingly, each single PDP context can be mapped to two Terminations.

It can be noted that the distinction between primary and secondary PDP contexts is a distinction that is important in the control plane but is not always important to a particular user-plane entity or peer. For example, the user plane need not see a difference between primary and secondary PDP contexts. It will be appreciated that it is not necessary for a peer to have a split architecture; an MG communicates with that portion of the peer that is comparable to a user-plane entity.

The SGSN/Media Gateway shown in FIG. 6 communicates with peer nodes (e.g., other user-plane entities) via GTP tunnels. As noted above, a GTP tunnel is a uni-directional data path between two network nodes or peers through which a packet data flow can be sent, e.g., a data stream path between two associated single PDP contexts in different GSNs. Eight respective GTP tunnels link the media gateway to each of the two peer nodes shown.

In accordance with the invention, the two (GPRS) GTP tunnels related to a single PDP context (either a primary PDP context or a secondary PDP context) and going towards the same user-plane peer node are advantageously mapped to an H.248/MEGACO-protocol Stream. A (GPRS) GTP tunnel for received packets is mapped to an H.248/MEGACO-protocol Local Descriptor, and a (GPRS) GTP tunnel for sent packets is mapped to a H.248/MEGACO-protocol Remote Descriptor.

Applicants' invention removes an important drawback of the current absence of a mapping of concepts between Media Gateway Control protocols (e.g., H.248/MEGACO) and specifications for packet-switched systems like GPRS (GPRS/UMTS and GSM/GPRS). In particular, Applicants' invention enables Media Gateway Control protocols for the Media Controller/Media Gateway split to be applied in an environment in which many vendors supply control- and user-plane entities.

It is currently believed that the concept mapping described above is not limited to the H.248/MEGACO protocol but can be used for mapping other Media Gateway Control protocols into a GPRS network, provided these other protocols use concepts that are suitably similar to the concepts used in the H.248/MEGACO protocol. One way to determine such concepts is to look for their “connection-oriented” aspects. For example, the H.248/MEGACO protocol can be considered as relating to “half-calls” that are deconstructions of bidirectional communications into “A-subscriber sides” and “B-subscriber sides. In addition, Applicants' concept mapping should apply both for GPRS/UMTS and GPRS/GSM networks having one or more nodes, e.g., GSNs, split into Media Controllers and Media Gateways.

Applicants' invention is described above in connection with various embodiments that are intended to be illustrative, not restrictive. It is expected that those of ordinary skill in this art will modify these embodiments. The scope of Applicants' invention is defined by the following claims, and all modifications that fall within the scopes of these claims are intended to included therein.

What is claimed is:

1. A method of formatting communication in a telecommunication network having a control-plane entity and a user-plane entity and providing a general packet radio service (GPRS), the method comprising the step of representing in a user-plane entity at least a part of a GPRS mobility management context as a context in accordance with a media gateway control protocol.

2. A method of formatting communication in a telecommunication network having a control-plane entity and a user-plane entity and providing a general packet radio service (GPRS), the method comprising the step of representing in the user-plane entity at least a part of a GPRS packet data protocol (PDP) context going towards a GPRS user-plane peer as a termination in accordance with a media gateway control protocol.

3. The method of claim 2, wherein the GPRS PDP context contains information related to one communication session and is one of a primary GPRS PDP context and a secondary GPRS PDP context.

4. The method of claim 2, wherein the GPRS PDP context contains information related to a plurality of communication sessions and is one primary GPRS PDP context and zero or more secondary GPRS PDP contexts.

5. A method of formatting information in a telecommunication network having a control-plane entity and a user-plane entity and providing a general packet radio service (GPRS), the method comprising the step of representing in the user-plane entity two GPRS tunneling protocol (GTP) tunnels related to a single GPRS packet data protocol (PDP) context and going towards a common user-plane peer as a stream in accordance with a media gateway control protocol.

6. The method of claim 5, wherein the GPRS PDP context is one of a primary PDP context and a secondary PDP context.

7. The method of claim 5, wherein a GTP tunnel containing received packets is represented by a local descriptor in accordance with the media gateway control protocol.

8. The method of claim 5, wherein a GTP tunnel containing sent packets is represented by a remote descriptor in accordance with the media gateway control protocol.
